(19) United States
(12) Patent Application Publication
(10) Pub. No.: US 2020/0334192 A1
(43) Pub. Date: Oct. 22, 2020

(54) COMMUNICATION METHOD, DEVICE, AND SYSTEM

(71) Applicant: SZ DJI TECHNOLOGY CO., LTD., Shenzhen (CN)

(72) Inventors: Weihong ZHENG, Shenzhen (CN); Shibo WANG, Shenzhen (CN); You ZHOU, Shenzhen (CN)

(21) Appl. No.: 16/919,852

(22) Filed: Jul. 2, 2020

Related U.S. Application Data
(63) Continuation of application No. PCT/CN2018/071673, filed on Jan. 5, 2018.

(51) Int. Cl. G06F 13/42

(52) U.S. Cl. CPC G06F 13/4282; G06F 2213/0042

(57) ABSTRACT

A communication method including a first device sending a registration request to a second device through a Universal Serial Bus (USB) interface of the first device. The registration request requests to register the first device with the second device and includes registration information of the first device. The registration information includes a registration key. The method further includes the first device receiving a registration response through the USB interface. The registration response is sent by the second device according to the registration key and confirms the first device is successfully registered with the second device. The method also includes the first device communicating with the second device via the USB interface.

### CROSS-REFERENCE TO RELATED APPLICATION

This application is a continuation of International Application No. PCT/CN2018/071673, filed on Jan. 5, 2018, the entire content of which is incorporated herein by reference.

### TECHNICAL FIELD

The present disclosure relates to the technical field of unmanned aerial vehicle (UAV) and, more particularly, to a communication method, device, and system.

### BACKGROUND

Universal Serial Bus (USB) interfaces are widely used in smart phones, computers and other electronic products. Many function plug-ins are developed based on the USB interface. Therefore, the electronic products are connected to the function plug-ins through the USB interfaces provided on them. Fast data transmission is performed and hot plugging is supported through the USB interfaces, such that the electronic products have the functions of these function plug-ins. However, since a manufacturer of an unmanned aerial vehicle (UAV) has a private communication protocol, how to communicate with the function plug-ins having the USB interfaces is an urgent problem to be solved.

### SUMMARY

In accordance with the disclosure, there is provided a communication method including a first device sending a registration request to a second device through a Universal Serial Bus (USB) interface of the first device. The registration request requests to register the first device with the second device and includes registration information of the first device. The registration information includes a registration key. The method further includes the first device receiving a registration response through the USB interface. The registration response is sent by the second device according to the registration key and confirms the first device is successfully registered with the second device. The method also includes the first device communicating with the second device via the USB interface.

Also in accordance with the disclosure, there is provided a communication method including receiving a registration request sent by a first device by a second device through a Universal Serial Bus (USB) interface of the second device. The registration request requests to register the first device with the second device. The registration request includes registration information of the first device, and the registration information includes a registration key. The method further includes the second device saving the registration information in response to determining, according to the registration key, that the first device is authorized to communicate with the second device, and the second device sending a registration response to the first device through the USB interface. The registration response confirms a successful registration. The method also includes the second device communicating with the first device through the USB interface.

Also in accordance with the disclosure, there is provided a communication device including a Universal Serial Bus (USB) interface and a processor coupled to the USB interface. The processor is configured to send a registration request to another device through the USB interface. The registration request requests to register the communication device with the another device and includes registration information of the communication device. The registration information includes a registration key. The processor is further configured to receive a registration response through the USB interface. The registration response is sent by the another device according to the registration key. The processor is also configured to communicate with the another device via the USB interface.

Also in accordance with the disclosure, there is provided a communication device configured to communicate with another device. The communication device includes a Universal Serial Bus (USB) interface, a memory, and a processor coupled to the USB interface and the memory. The processor is configured to receive a registration request through the USB interface. The registration request is sent by the another device and requests to register the another device with the communication device. The registration request includes registration information of the another device, and the registration information includes a registration key. The processor is further configured to save the registration information to the memory in response to determining, according to the registration key, that the another device is authorized to communicate with the communication device, and send a registration response to the another device through the USB interface. The registration response confirms a successful registration. The processor is also configured to communicate with the another device through the USB interface.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1 is a schematic architectural diagram of an unmanned aerial system consistent with embodiments of the disclosure.

FIG. 2 a schematic flow chart of a communication method consistent with embodiments of the disclosure.

FIG. 3 a schematic flow chart of another communication method consistent with embodiments of the disclosure.

FIG. 4 is a schematic structural diagram of a communication device consistent with embodiments of the disclosure.

FIG. 5 is a schematic structural diagram of another communication device consistent with embodiments of the disclosure.

FIG. 6 is a schematic structural diagram of a communication system consistent with embodiments of the disclosure.

FIG. 7 is a schematic structural diagram of another communication system consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure. Unless conflicting, the exemplary embodiments and features in the exemplary embodiments can be combined with each other.

The present disclosure provides a communication method, device, and system. An associated unmanned aerial vehicle (UAV) may include a rotorcraft, for example, a multirotor aircraft propelled by multiple propulsion devices through air, which is not limited herein.

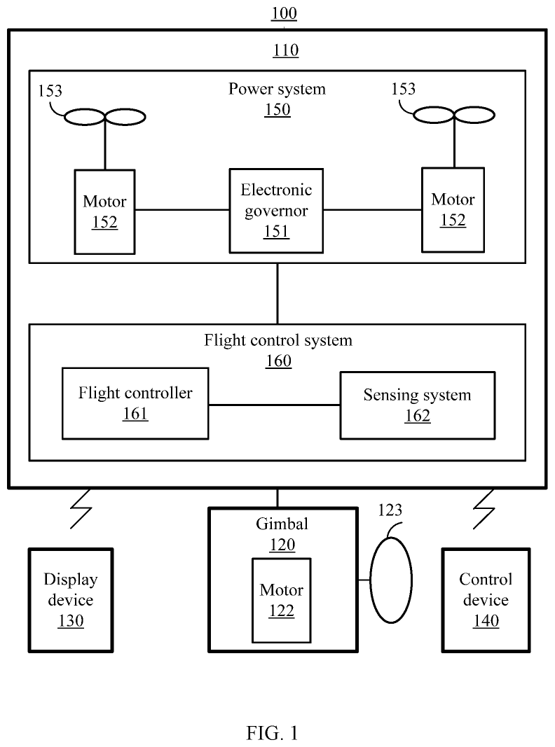

FIG. 1 is a schematic architectural diagram of an example unmanned aerial system 100 consistent with the disclosure. As shown in FIG. 1, the unmanned aerial system 100 includes a UAV 110, a gimbal 120, a display device 130, and a control device 140. Taking the rotorcraft as an example of the UAV 110, the UAV 110 includes a power system 150, a flight control system 160, and a rack. The UAV 110 can wirelessly communicate with the control device 140 and the display device 130.

The rack may include a body and a stand (also referred to as landing gear). The body may include a center frame and one or more arms connected to the center frame. The one or more arms can extend radially from the center frame. The stand can be connected to the body for supporting the UAV 110 when the UAV 110 lands.

The power system 150 includes one or more electronic governors 151, one or more propellers 153, and one or more motors 152 corresponding to the one or more propellers 153. Each motor 152 can be connected between the corresponding electronic governor 151 and the corresponding propeller 153, and the one or more motors 152 and the one or more propellers 153 can be arranged at the arms of the UAV 110. The one or more electronic governors 151 can be configured to receive a driving signal(s) generated by the flight control system 160 and provide a driving current(s) to the one or more motors 152 according to the driving signal(s) to control a rotation speed(s) of the one or more motors 152. The one or more motors 152 can be configured to drive the one or more propellers to rotate, thereby providing a power for a flight of the UAV 110, which enables the UAV 110 to achieve one or more degrees of freedom of movement. In some embodiments, the UAV 110 can rotate around one or more rotation axes. For example, the one or more rotation axes may include a roll axis, a yaw axis, and a pitch axis. The one or more motors 152 may include one or more direct current (DC) motors or one or more alternating current (AC) motors. The one or more motors 152 may include one or more brushless motors or one or more brush motors.

The flight control system 160 includes a flight controller 161 and a sensing system 162. The sensing system 162 can be configured to measure attitude information of the UAV 110, for example, position information and status information of the UAV 110 in space (e.g., a three-dimensional position, a three-dimensional angle, a three-dimensional velocity, a three-dimensional acceleration, a three-dimensional angular velocity, and the like). The sensing system 162 may include, for example, at least one of a gyroscope, an ultrasonic sensor, an electronic compass, an inertial measurement unit (IMU), a visual sensor, a global navigation satellite system, or a barometer. For example, the global navigation satellite system may include a global positioning system (GPS). The flight controller 161 can be configured to control the flight of the UAV 110. For example, the flight of the UAV 110 can be controlled according to the attitude information measured by the sensing system 162. The flight controller 161 can control the UAV 110 according to pre-programmed program instructions, or can control the UAV 110 in response to one or more control commands from the control device 140.

The gimbal 120 includes a motor 122. The gimbal can be configured to carry an imaging device 123. The flight controller 161 can control movement of the gimbal 120 through the motor 122. In some embodiments, the gimbal 120 may further include a controller for controlling the movement of the gimbal 120 by controlling the motor 122. It can be appreciated that the gimbal 120 may be independent of the UAV 110 or may be a part of the UAV 110. The motor 122 may include a DC motor or an AC motor. The motor 122 may include a brushless motor or a brush motor. The gimbal can be arranged at a top of the UAV 110 or at a bottom of the UAV 110.

The imaging device 123 may include, for example, a device for shooting images, e.g., a camera or a video camera, and the imaging device 123 may communicate with the flight controller 161 and shoot the images under a control of the flight controller 161. The imaging device 123 can at least include a photosensitive element, for example, a complementary metal oxide semiconductor (CMOS) sensor or a charge-coupled device (CCD) sensor.

The display device 130 can be arranged at a ground end of the unmanned aerial system 100, can communicate with the UAV 110 in a wireless manner, and can be configured to display the attitude information of the UAV 110. The images shot by the imaging device 123 may also be displayed on the display device 130. It can be appreciated that the display device 130 may be an independent device or may be integrated in the control device 140.

The control device 140 can be arranged at the ground end of the unmanned aerial system 100, and can communicate with the UAV 110 in the wireless manner for remotely controlling the UAV 110.

The naming of the components of the unmanned aerial system 100 described above is merely for identifying different components and not intended to limit the present disclosure. It can be appreciated that the UAV 110 may include all or some of the components described above.

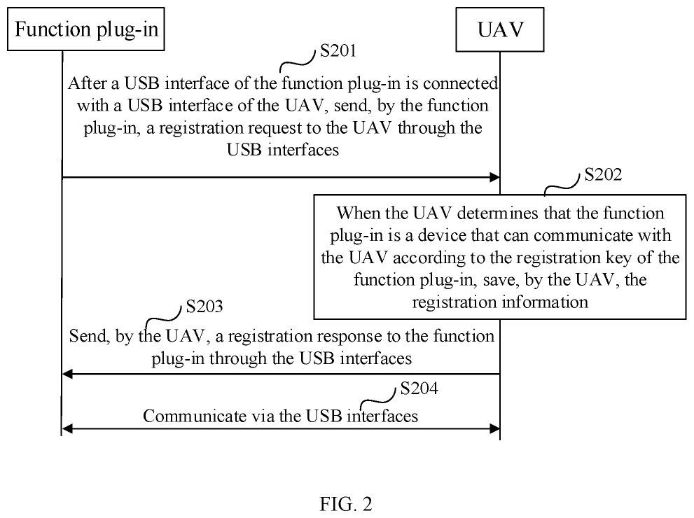

FIG. 2 a schematic flow chart of an example communication method consistent with the disclosure. Herein, a function plug-in is taken as an example of a first device and a UAV is taken as an example of a second device, which are not intended to limit the disclosure. In some embodiments, the first device and the second device can both include UAVs.

As shown in FIG. 2, at S201, after a Universal Serial Bus (USB) interface of the function plug-in is connected with a USB interface of the UAV, the function plug-in sends a registration request to the UAV through the USB interfaces. The function plug-in can have the USB interface, and the function plug-in can include, for example, a camera plug-in, a capture plug-in, a light plug-in, a speaker plug-in, or the like. The UAV can have the USB interface, such that the function plug-in and the UAV can be connected through the USB interface of the UAV and the USB interface of the function plug-in, i.e., the USB interface of the function plug-in can be connected to the USB interface of the UAV. For example, the user may connect the USB interface of the function plug-in to the USB interface of the UAV to realize a connection between the USB interface of the function plug-in and the USB interface of the UAV. In some embodiments, the USB interface can include a micro USB interface.

After the USB interface of the function plug-in is connected to the USB interface of the UAV, the function plug-in can send the registration request to the UAV through the USB interfaces, and the UAV can receive, through the USB interfaces, the registration request sent by the function plug-in. The registration request can request the function plug-in to register with the UAV. The registration request can include registration information of the first device, and the registration information can include a registration key.

At S202, when the UAV determines that the function plug-in is a device that can communicate with the UAV according to the registration key of the function plug-in, the UAV saves the registration information. In some embodiments, after receiving the registration request sent by the UAV, the UAV can determine whether the function plug-in is a device that can communicate with the UAV, i.e., whether the function plug-in is authorized to communicate with the UAV, according to the registration key. When the UAV determines that the function plug-in is a device that can communicate with the UAV according to the registration key, the UAV and the function plug-in can communicate, and the UAV can save the registration information of the function plug-in and execute the processes at S203 and S204. When the UAV determines that the function plug-in is not a device that can communicate with the UAV according to the registration key, the UAV and the function plug-in cannot communicate, and then the UAV does not execute S202-S204.

In some embodiments, the UAV can determine whether the function plug-in is a device that can communicate with the UAV according to whether the registration key is a valid key. If the registration key is a valid key, the function plug-in can be a device that can communicate with the UAV. If the registration key is not a valid key, the function plug-in cannot be a device that can communicate with the UAV.

In some embodiments, at least one key is stored in the UAV. If the registration key belongs to the at least one key saved in the UAV, e.g., if the registration key matches one of the at least one key saved in the UAV, it indicates that the registration key is a valid key. If the registration key does not belong to the at least one key saved in the UAV, e.g., if the registration key does not match any of the at least one key saved in the UAV, it indicates that the registration key is not a valid key.

At S203, the UAV sends a registration response to the function plug-in through the USB interfaces. After saving the registration information of the function plug-in, the UAV can send the registration response to the function plug-in through the USB interfaces, and the registration response can confirm a successful registration. The function plug-in can receive, through the USB interfaces, the registration response sent by the UAV, and determine that the function plug-in has been successfully registered with the UAV according to the registration response.

At S204, the UAV and the function plug-in communicate via their USB interfaces. After the function plug-in is successfully registered with the UAV, the UAV can communicate with the function plug-in. For example, the UAV can send information (signaling and/or data) to the function plug-in through the USB interfaces, and the function plug-in can send information (signaling and/or data) to the UAV through the USB interfaces, thereby realizing the information transmission between the UAV and the function plug-in.

In some embodiments, after the USB interface of the function plug-in is connected to the USB interface of the UAV, the function plug-in can send the registration request to the UAV, and the registration request can request the function plug-in to register with the UAV. The registration request can include the registration information of the function plug-in, and the registration information can include the registration key. When the UAV determines that the function plug-in is a device that can communicate with the UAV according to the registration key of the function plug-in, the UAV can save the registration information and send the registration response to the function plug-in. The registration response can confirm the successful registration. Then the function plug-in can communicate with the UAV through the USB interfaces. Consistent with the disclosure, a registration process of the function plug-in with the UAV can be completed according to the registration key of the function plug-in, thereby realizing the communication through the USB interface.

In some embodiments, the registration key can be obtained from a manufacturer of the UAV. When developing the function plug-in, a developer can apply for at least one registration key from the UAV manufacturer. The registration key can be exclusive to the developer, the developer can develop at least one function plug-in. Each function plug-in may share the same registration key, or the same type of function plug-in can have multiple registration keys, and each registration key can be assigned to some function plug-ins in the same type of function plug-in.

In some embodiments, the registration information may further include a control authority of the function plug-in for controlling the UAV. The UAV can determine whether the function plug-in is a device that can communicate with the UAV according to not only the registration key but also the control authority. For example, when the UAV determines that the control authority is legitimate, the UAV can determine that the function plug-in is a device that can communicate with the UAV. The UAV can determine whether the control authority is legitimate to determine whether the function plug-in is a device that can communicate with the UAV. If the control authority is legitimate, the UAV can determine that the function plug-in is a device that can communicate with the UAV, and if the control authority is not legitimate, the UAV can determine that the function plug-in is not a device that can communicate with the UAV. In some embodiments, the UAV can open at least one control authority to the outside. If the control authority of the function plug-in with respect to the UAV belongs to the opened control authority of the UAV, it indicates that the control authority of the function plug-in with respect to the UAV is legitimate. If the control authority of the function plug-in with respect to the UAV does not belong to the opened control authority of the UAV, it indicates that the control authority of the function plug-in with respect to the UAV is not legitimate.

In some embodiments, the registration information can further include data attribute(s) of data requested by the function plug-in from the UAV, i.e., data attribute(s) of data that the function plug-in is to obtain from the UAV. The UAV can determine whether the function plug-in is a device that can communicate with the UAV according to not only the registration key but also the data attribute(s). For example, when the UAV determines that the data attribute(s) is legitimate, the UAV can determine that the function plug-in is a device that can communicate with the UAV. The UAV can determine whether the data attribute(s) is legitimate to determine whether the function plug-in is a device that can communicate with the UAV. If the data attribute(s) is legitimate, the UAV can determine that the function plug-in is a device that can communicate with the UAV, and if the data attribute(s) is not legitimate, the UAV can determine that the function plug-in is not a device that can communicate with the UAV. In some embodiments, the UAV can open at least one data attribute to the outside, such as a flight speed, a flight position, and/or the like. If the data attribute(s) belongs to the at least one opened data attribute of the UAV, it indicates that the control authority of the function plug-in with respect to the UAV is legitimate. If the data attribute(s) does not belong to the at least one opened data attribute of the UAV, it indicates that the control authority of the function plug-in with respect to the UAV is not legitimate. In some embodiments, the registration information can further include how often the function plug-in can obtain the data from the UAV.

In some embodiments, the registration information can further include identification information of the function plug-in. In some embodiments, the UAV can include a plurality USB ports, and hence, the UAV can be connected to a plurality of function plug-ins through the plurality of USB ports at the same time. As such, the UAV can distinguish each function plug-in through the identification information of the function plug-in.

In some embodiments, the registration information can further include endpoint numbers and the number of endpoints (e.g., 3) needed by the function plug-in, interface numbers and the number of interfaces (e.g., 2) needed by the function plug-in, and a driving current needed by the function plug-in. In some embodiments, the UAV can further determine whether the function plug-in is a device that can communicate with the UAV according to the endpoint numbers needed by the function plug-in and the interface numbers needed by the function plug-in. When the endpoint numbers needed by the function plug-in and the interface numbers needed by the function plug-in are both legitimate, the function plug-in can be determined to be a device that can communicate with the UAV.

In some embodiments, the registration information can further include redundant data bits for upgrading in a later time. In some embodiments, the registration information can include 512 bytes of data.

In some embodiments, after the function plug-in is successfully registered with the UAV, the function plug-in can regularly send a heartbeat message to the UAV through the USB interface. The UAV can regularly receive, through the USB interfaces, the heartbeat message sent by the function plug-in, and determine the function plug-in is online according to the received heartbeat message. Thus, the USB interface of the function plug-in can be connected to the USB interface of the UAV. If the UAV does not receive, through the USB interfaces, the heartbeat message sent by the function plug-in within a preset time period, it indicates that the function plug-in is not online and the function plug-in has been disconnected from the USB interface of the UAV, and the UAV can delete the registration information of the saved function plug-in.

In some embodiments, when the user needs to disconnect the function plug-in from the USB interface of the UAV, the user can operate the function plug-in, such that the function plug-in can send a registration cancellation request to the UAV through the USB interface according to a user's operation. The registration cancellation request can request cancellation of the registration of the function plug-in with the UAV. The user can then disconnect the function plug-in from the USB interface of the UAV. The UAV can receive the registration cancellation request sent by the function plug-in, and delete the registration information of the saved function plug-in according to the registration cancellation request for saving space.

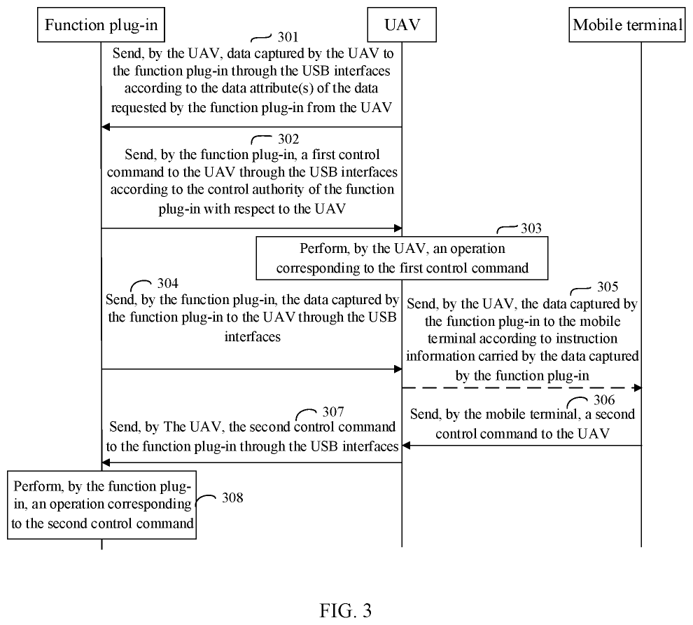

After the function plug-in is successfully registered with the UAV, the communication between the function plug-in and the UAV through the USB interfaces will be described below. FIG. 3 is a schematic flow chart of another example communication method consistent with the disclosure. As shown in FIG. 3, after the processes at S201 to S203, the method may further include the following processes.

At S301, the UAV sends data captured by the UAV to the function plug-in through the USB interfaces according to the data attribute(s) of the data requested by the function plug-in from the UAV. The UAV can capture the data, and then the UAV can send the data captured by the UAV to the function plug-in through the USB interfaces according to the data attribute(s) of the data requested by the function plug-in from the UAV. The function plug-in can receive, through the USB interfaces, the data sent by the UAV. For example, the UAV can capture the flight speed, a flight acceleration, a flight attitude angle, the flight position, and/or the like. If the data attributes of the data requested by the function plug-in from the UAV include the flight speed and the flight attitude angle, the UAV can send the flight speed and the flight attitude angle to the function plug-in through the USB interfaces.

In some embodiments, the UAV can package the captured data according to a communication protocol between the USB interface of the UAV and the USB interface of the function plug-in, and then send a data packet to the function plug-in. The data packet can refer to the captured data after being packaged. The function plug-in can receive the data packet, and then decode the data packet to obtain the data captured by the UAV.

In some embodiments, an example implementation manner of the processes at S301 may include: sending, by the UAV, the data captured by the UAV to the function plug-in through the USB interfaces according to the data attribute(s) of the data requested by the function plug-in from the UAV and the frequency of obtaining the data by the function plug-in from the UAV. For example, if the frequency is 1 Hz, the UAV can send the captured data to the function plug-in every 1 second.

At S302, the function plug-in sends a first control command to the UAV through the USB interfaces according to the control authority of the function plug-in with respect to the UAV.

At S303, the UAV performs an operation corresponding to the first control command. The function plug-in can send the first control command to the UAV through the USB interfaces according to its control authority to the UAV. The UAV can receive, through the USB interfaces, the first control command sent by the function plug-in, and execute the operation corresponding to the first control command according to the first control command.

In some embodiments, another example implementation manner of the processes at S302 may include: sending, by the function plug-in, the first control command to the UAV through the USB interfaces according to the control authority and at least one of the data captured by the function plug-in or the data received from the UAV. For example, the function plug-in may include a gesture control plug-in that can capture gesture information in the environment and receive sensor data, e.g., the flight speed and the flight attitude of the UAV, from the UAV. The gesture control plug-in can capture the gesture information in the environment, and the sensor data, e.g., the flight speed and the flight attitude of the UAV, according to the control authority of the UAV, to generate a gesture control command, thereby realizing a control of the UAV via a gesture.

At S304, the function plug-in sends the data captured by the function plug-in to the UAV through the USB interfaces. The function plug-in can capture the data, and then send the captured data to the UAV through the USB interfaces. The UAV can receive, through the USB interfaces, the data sent by the function plug-in. For example, the function plug-in can include a camera plug-in, and the data captured by the camera plug-in can include a shot image. For example, after obtaining the shot image from the camera plug-in, the UAV can perform an obstacle avoidance operation.

In some embodiments, the function plug-in can package the captured data according to the communication protocol between the USB interface of the function plug-in and the USB interface of the UAV, and then send the data packet to the UAV. The UAV can receive the data packet, and then decode the data packet to obtain the data captured by the function plug-in.

In some embodiments, the method can further include the processes at S305 after the processes at S304.

At S305, the UAV sends the data captured by the function plug-in to the mobile terminal according to instruction information carried by the data captured by the function plug-in.

Taking a mobile terminal as an example of a third device, the data captured by the function plug-in and sent by the function plug-in to the UAV can carry the instruction information. The instruction information can instruct the mobile terminal to receive the data captured by the function plug-in. The UAV can send the data captured by the function plug-in to the mobile terminal according to the instruction information, thereby realizing a transparent transmission of data between the function plug-in and the mobile terminal. The UAV can send the data captured by the function plug-in to the mobile terminal in the wireless manner (e.g., WiFi).

At S306, the mobile terminal sends a second control command to the UAV.

At S307, the UAV sends the second control command to the function plug-in through the USB interfaces.

At S308, the function plug-in performs an operation corresponding to the second control command.

In some embodiments, the mobile terminal may send the second control command to the UAV via the wireless manner (e.g., WiFi), and the second control command may carry a forwarding instruction. The UAV can receive the second control command sent by the mobile terminal, and the UAV can forward the second control command to the function plug-in through the USB interfaces, thereby achieving the transparent transmission of the control command between the mobile terminal and the function plug-in. After receiving, through the USB interfaces, the second control command forwarded by the UAV, the function plug-in can perform the corresponding operation according to the second control command. For example, the function plug-in can include a hand-grab plug-in, and the user can send a grab command to the function plug-in through the UAV by operating the mobile terminal, and control the hand-grab plug-in to grab objects.

Consistent with the disclosure, the communication between the UAV and the function plug-in can be achieved through the methods described above. It can be appreciated that an execution order of the processes at S301, the processes at S302 and S303, the processes at S304 and S305, and the processes at S306 to S308 is not limited herein. In some embodiments, after the processes at S201 to S203 are executed, one or more of the process at S301, the processes at S302 and S303, the processes at S304 and S305, and the processes at S306 to S308 may be executed, or all of them may be executed.

In some embodiments, before one or more of the process at S301, the processes at S302 and S303, the processes at S304 and S305, and the processes at S306 to S308 are executed, the processes at S201 to S203 may not need to be executed. That is, before one or more of the processes at S301, the processes at S302 and S303, the processes at S304 and S305, and the processes at S306 to S308, the registration process at S201 to S203 may not need. The control authority of the function plug-in with respect to the UAV may include all control authorities of the UAV opened to the outside. The data attribute of the data requested by the function plug-in from the UAV may include the data attributes of all data that the UAV allows the outside to obtain. The frequency can include a preset frequency in the UAV.

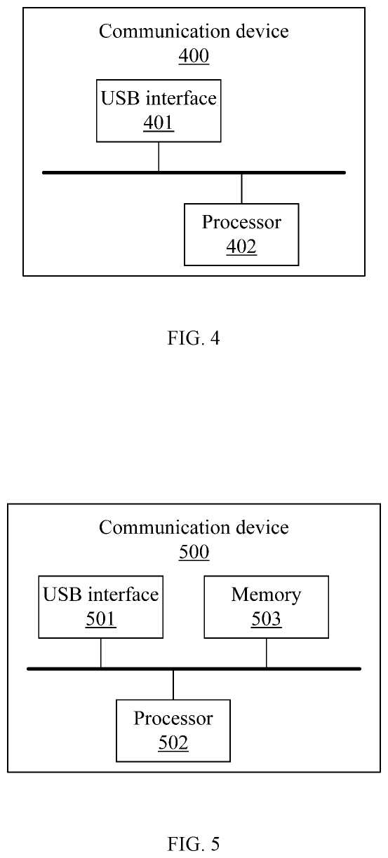

FIG. 4 is a schematic structural diagram of an example communication device 400 consistent with the disclosure. The communication device 400 can be used as the first device and includes a USB interface 401 and a processor 402 coupled to the USB interface 401.

The processor 402 can be configured to send the registration request to the second device through the USB interface 401 after the USB interface 401 is connected to a USB interface of the second device, and the registration request can request the first device to register with the second device. The registration request can include the registration information of the first device, and the registration information can include the registration key.

The registration response sent by the second device according to the registration key of the first device can be received through the USB interface 401, and the registration response can confirm the successful registration. The first device can communicate with the second device through the USB interface 401.

In some embodiments, the registration key can be obtained from a manufacturer of the second device. In some embodiments, the registration information can further include the control authority of the first device to the second device.

In some embodiments, the processor 402 can be configured to send the first control command to the second device through the USB interface 401 according to the control authority.

In some embodiments, the processor 402 can be configured to capture the data, and send the first control command to the second device through the USB interface 401 according to the control authority, the data captured by the first device, and/or the data received from the second device.

In some embodiments, the registration information can further include the data attribute(s) of the data requested by the first device from the second device.

In some embodiments, the processor 402 can be configured to receive, through the USB interface 401, the data captured by the second device and sent by the second device according to the data attribute(s).

In some embodiments, the registration information can further include the frequency at which the first device obtain data from the second device.

In some embodiments, the processor 402 can be configured to receive, through the USB interface 401, the data captured by the second device and sent by the second device according to the frequency and the data attribute(s).

In some embodiments, the processor 402 can be configured to receive, through the USB interface 401, the second control command sent by the second device. The second control command can be received by the second device from the third device and the processor 402 can be configured to perform the operation corresponding to the second control command.

In some embodiments, the processor 402 can be configured to send the data captured by the first device to the second device through the USB interface 401.

In some embodiments, the data captured by the first device can carry the instruction information, and the instruction information can instruct the third device to receive the data captured by the first device.

In some embodiments, the processor 402 can be further configured to send the registration cancellation request to the second device through the USB interface 401 according to the user's operation on the first device. The registration cancellation request can request the cancellation of registration of the first device with the second device.

In some embodiments, the registration information can further include the identification information of the first device.

In some embodiments, the communication device 400 can include the function plug-in, or the communication device 400 can include the UAV.

The communication device consistent with the disclosure may be used to execute the technical solution of the function plug-in in the methods in FIGS. 2 and 3, and the implementation principles and technical effects of the communication device are similar to the implementation principles and technical effects of the methods in FIGS. 2 and 3, and detailed description thereof is omitted herein.

FIG. 5 is a schematic structural diagram of an example communication device 500 consistent with the disclosure. The communication device 500 can be used as the second device and includes a USB interface 501, a processor 502 coupled to the USB interface 501, and a memory 503 couple to the processor 502.

The processor 502 can be configured to receive, through the USB interface 501, the registration request sent by the first device after the USB interface 501 is connected to the USB interface of the first device. The registration request can include the registration information of the first device, and the registration information can include the registration key. The processor 502 can be further configured to determine whether the first device is a device that can communicate with the second device according to the registration key of the first device.

The memory 503 can be configured to save the registration information when the processor 502 determines that the first device is a device that can communicate with the second device according to the registration key of the first device.

The processor 502 can be further configured to send the registration response to the first device through the USB interface 501, and the registration response can confirm the successful registration. The processor 502 can be further configured to communicate with the first device through the USB interface 501.

In some embodiments, the registration key can be obtained from a manufacturer of the second device.

In some embodiments, the registration information can further include the control authority of the first device to the second device.

The processor 502 can be configured to, when determining the control authority is legitimate, determine that the first device is a device that can communicate with the second device.

In some embodiments, the processor 502 can be configured to receive, through the USB interface 501, the first control command sent by the first device according to the control authority, and perform the operation corresponding to the first control command.

In some embodiments, the registration information can further include the data attribute(s) of the data obtained by the first device from the second device.

The processor 502 can be configured to, when determining that the data attribute(s) is legitimate, determine that the first device is a device that can communicate with the second device.

In some embodiments, the processor 502 can be configured to send the data captured by the second device to the first device through the USB interface 501 according to the data attribute(s).

In some embodiments, the registration information can further include the frequency with which the first device obtains the data from the second device.

In some embodiments, the processor 502 can be configured to send the data captured by the second device to the first device through the USB interface 501 according to the data attribute(s) and the frequency.

In some embodiments, the processor 502 can be configured to send the second control command to the first device through the USB interface 501, and the second control command can be received by the second device from the third device.

In some embodiments, the processor 502 can be configured to receive, through the USB interface 501, the data captured by the first device and sent by the first device.

In some embodiments, the data captured by the first device can carry the instruction information, and the instruction information can instruct the third device to receive the data captured by the first device.

The processor 502 can be further configured to send the data captured by the first device to the third device according to the instruction information.

In some embodiments, the processor 502 can be further configured to delete the registration information stored in the memory 503, if the heartbeat message sent by the first device is not received through the USB interface 501 within the preset time period.

In some embodiments, the processor 502 can be further configured to receive, through the USB interface 501, the registration cancellation request sent by the first device. The registration cancellation request can request the cancellation of registration of the first device with the second device. The processor 502 can be further configured to delete the registration information stored in the memory 503 according to the registration cancellation request.

In some embodiments, the registration information can further include the identification information of the first device. In some embodiments, the communication device 500 can include the UAV.

The communication device consistent with the disclosure may be used to execute the technical solution of the function plug-in in the methods in FIGS. 2 and 3, and the implementation principles and technical effects of the communication device are similar to the implementation principles and technical effects of the methods in FIGS. 2 and 3, and detailed description thereof is omitted herein.

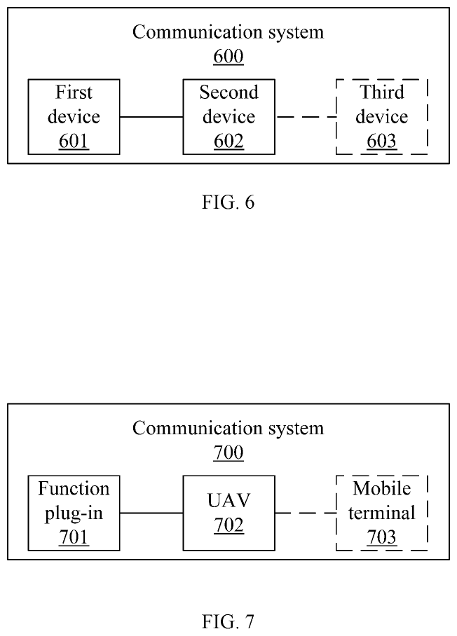

FIG. 6 is a schematic structural diagram of an example communication system 600 consistent with the disclosure. As shown in FIG. 6, the communication system 600 includes a first device 601 and a second device 602. The first device 601 may have a structure of the device shown in FIG. 4, and may execute the technical solutions of the function plug-in in any of the methods in FIGS. 2 and 3. The implementation principles and technical effects of the first device 601 are similar to the implementation principles and technical effects of the methods in FIGS. 2 and 3, and detailed description thereof is omitted herein. The second device 602 may have a structure of the device shown in FIG. 5, and may execute the technical solutions of the function plug-in in any of the methods in FIGS. 2 and 3. The implementation principles and technical effects of the second device 602 are similar to the implementation principles and technical effects of the methods in FIGS. 2 and 3, and detailed description thereof is omitted herein.

In some embodiments, the first device 601 can include the function plug-in, and the second device 602 can include the UAV, or both the first device 601 and the second device 602 can include UAVs.

In some embodiments, the communication system 600 may further include a third device 603. The third device 603 can be configured to receive the data captured by the first device 601 and forwarded by the second device 602, and send the second control command to the first device 601 through forwarding by the second device 602. Therefore, the communication system 600 can achieve the transparent transmission of the data and control commands between the first device 601 and the third device 603. In some embodiments, the third device 603 can include the mobile terminal.

FIG. 7 a schematic structural diagram of an example communication system 700 consistent with the disclosure. As shown in FIG. 7, the communication system 700 includes a function plug-in 701 and a UAV 702.

The function plug-in 701 can be configured to send the data captured by the function plug-in 701 to the UAV 702 through the USB interfaces after the USB interface of the function plug-in 701 is connected to the USB interface of the UAV 702, receive, through the USB interfaces, the data captured by the UAV 702 sent by the UAV 702, and send the first control command to the UAV 702 through the USB interfaces according to the data captured by the function plug-in 701 and the data collected by the UAV 702.

The UAV 702 can be configured to, after the USB interface of the UAV 702 is connected to the USB interface of the function plug-in 701, sent the data captured by the UAV 702 to the function plug-in 701 through the USB interfaces, receive, through the USB interfaces, the data captured by the function plug-in and sent by the function plug-in 701, receive, through the USB interfaces, the first control command sent by the function plug-in 701, and execute the operation corresponding to the first control command.

In some embodiments, the communication system 700 further includes a mobile terminal 703.

The UAV 702 can be further configured to forward the data captured by the function plug-in 701 to the mobile terminal 703, receive the second control command sent by the mobile terminal 703 and forward the second control command to the function plug-in 701.

The function plug-in 701 can be further configured to receive, through the USB interfaces, the second control command forwarded by the UAV 702, and perform the operation corresponding to the second control command.

The mobile terminal 703 can be configured to receive the data captured by the function plug-in 701 and forwarded by the UAV 702, and send the second control command to the function plug-in 701 through forwarding by the UAV 702.

The communication system 700 may be configured to execute the technical solution of the method shown in FIG. 3. The implementation principles and technical effects of the communication system 700 are similar to the implementation principles and technical effects of the method in FIG. 3, and detailed description thereof is omitted herein.

Some or all of the processes of the method described above can be executed by hardware running program instructions. The program may be stored in a computer-readable storage medium. When the program is executed, the processes of the method are executed. The computer-readable storage medium can include a read-only memory (ROM), a random-access memory (RAM), a magnetic disk, an optical disk, or another medium that can store program codes.

It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. A communication method comprising:
sending, by a first device, a registration request to a second device through a Universal Serial Bus (USB) interface of the first device, the registration request requesting to register the first device with the second device and including registration information of the first device, and the registration information including a registration key;
receiving, by the first device through the USB interface, a registration response sent by the second device according to the registration key, the registration response confirming the first device is successfully registered with the second device; and
communicating, by the first device, with the second device via the USB interface.

2. The method of claim 1, wherein the registration key is obtained from a manufacturer of the second device.

3. The method of claim 1, wherein the registration information further includes a control authority of the first device for controlling the second device.

4. The method of claim 3, wherein communicating with the second device includes:
sending, by the first device, a control command to the second device through the USB interface according to the control authority.

5. The method of claim 3, wherein sending the control command includes:
sending, by the first device, the control command to the second device through the USB interface according to the control authority and at least one of data captured by the first device or data received from the second device.

6. The method of claim 1, wherein the registration information further includes a data attribute of data that the first device is to obtain from the second device.

7. The method of claim 6, wherein communicating with the second device includes:
receiving, by the first device through the USB interface, data captured by the second device and sent by the second device according to the data attribute.

8. The method of claim 6, wherein the registration information further includes a frequency at which the first device obtains data from the second device.

9. The method of claim 8, wherein communicating with the second device includes:
receiving, by the first device through the USB interface, data captured by the second device and sent by the second device according to the frequency and the data attribute.

10. The method of claim 1,
wherein communicating with the second device includes:
receiving, by the first device through the USB interface, a control command sent by the second device, the control command being received by the second device from a third device;
the method further comprising:
performing, by the first device, an operation corresponding to the control command.

11. The method of claim 1, wherein communicating with the second device includes:
sending, by the first device, data captured by the first device to the second device through the USB interface.

12. The method of claim 11, wherein the data captured by the first device includes instruction information, the instruction information instructing a third device to receive the data captured by the first device.

13. The method of claim 1, further comprising:
sending, by the first device, a registration cancellation request to the second device through the first USB interface according to a user operation on the first device, the registration cancellation request requesting cancellation of registration of the first device with the second device.

14. The method of claim 1, wherein the registration information further includes identification information of the first device.

15. The method of claim 1, wherein:
the first device includes a function plug-in and the second device includes an unmanned aerial vehicle (UAV); or
each of the first device and the second device includes a UAV.

16. A communication method comprising:
receiving a registration request sent by a first device by a second device through a Universal Serial Bus (USB) interface of the second device, the registration request requesting to register the first device with the second device and including registration information of the first device, and the registration information including a registration key;
saving, by the second device, the registration information in response to determining, according to the registration key, that the first device is authorized to communicate with the second device;
sending, by the second device, a registration response to the first device through the USB interface, the registration response confirming a successful registration; and
communicating, by the second device, with the first device through the USB interface.

17. The method of claim 16, wherein the registration key is obtained from a manufacturer of the second device.

18. The method of claim 16, wherein:
the registration information further includes a control authority of the first device for controlling the second device; and
determining that the first device is authorized to communicate with the second device includes determining that the first device is authorized to communicate with the second device in response to determining that the control authority is legitimate.

19. A communication device comprising:
a Universal Serial Bus (USB) interface; and
a processor coupled to the USB interface and configured to:
send a registration request to another device through the USB interface, the registration request requesting to register the communication device with the another device and including registration information of the communication device, and the registration information including a registration key;
receive, through the USB interface, a registration response sent by the another device according to the registration key; and
communicate with the another device via the USB interface.

20. A communication device configured to communicate with another device, the communication device comprising:
a USB interface;
a memory; and
a processor coupled to the USB interface and the memory, and configured to:
receive, through the USB interface, a registration request sent by the another device, the registration request requesting to register the another device with the communication device and including registration information of the another device, and the registration information including a registration key;
save the registration information to the memory in response to determining, according to the registration key, that the another device is authorized to communicate with the communication device;
send a registration response to the another device through the USB interface, the registration response confirming a successful registration; and
communicate with the another device through the USB interface.
